(19) United States
(12) Patent Application Publication
(10) Pub. No.: US 2026/0120921 A1
(43) Pub. Date: Apr. 30, 2026

(54) SYSTEMS AND METHODS PROVIDING OPTICAL CABLE WITH TWISTED COPPER PAIRS

(71) Applicant: Zhone Technologies, Inc., Plano, TX (US)

(72) Inventor: Seung Dong Lee, Plano, TX (US)

(73) Assignee: Zhone Technologies, Inc., Plano, TX (US)

(21) Appl. No.: 19/348,691

(22) Filed: Oct. 2, 2025

Related U.S. Application Data
(60) Provisional application No. 63/712,914, filed on Oct. 28, 2024.

(51) Int. Cl. H01B 11/22; H01B 11/02; H01R 24/64

(52) U.S. Cl. CPC H01B 11/22; H01B 11/02; H01R 24/64

(57) ABSTRACT

A cable includes a fiber-optic cable in addition to a plurality of twisted conductive pairs. The fiber-optic cable and the twisted conductive pairs may be surrounded by a sheath. The sheath isolates the cable from the outside environment. Male and female connectors may be provided for use with the cable.

### CROSS-REFERENCE TO RELATED APPLICATIONS

The present application claims the benefit of United States Provisional Patent Application 63/712,914, filed October 28, 2024, the disclosure of which is hereby incorporated by reference in its entirety.

### TECHNICAL FIELD

The present disclosure relates to systems and methods that provide optical fiber in a cable with twisted copper pairs.

### SUMMARY

In one embodiment, a cable includes: a plurality of conducting twisted pairs; a fiber-optic cable; and a sheath disposed around the plurality of conducting twisted pairs and the fiber-optic cable.

In another embodiment, a device includes: a housing; a plurality of conductive terminations; and an optical connector, wherein the housing is configured to accommodate an inserted cable, wherein the plurality of conductive terminations are configured to terminate a plurality of conductive pairs of the cable, and wherein the optical connector is configured to terminate a fiber-optic cable within the cable.

In another embodiment, a device includes: a cable having an end, the cable further having a plurality of twisted conducting pairs and a fiber-optic cable contained within a sheath; and a male connector arranged at the end of the cable, wherein the male connector is configured to accommodate the end of the cable at least partly inside a housing of the male connector, wherein the male connector includes conductive terminations exposed at an outside surface the housing, the conductive terminations configured to terminate the plurality of twisted conducting pairs, further wherein the male connector includes an optical connector configured to terminate the fiber-optic cable.

### BRIEF DESCRIPTION OF THE DRAWINGS

Having thus described the invention in general terms, reference will now be made to the accompanying drawings, which are not necessarily drawn to scale, and wherein:

FIG. 1 illustrates an example cable having both twisted pairs and optical fiber, according to some embodiments.

FIG. 2 illustrates an example cable having both twisted pairs and optical fiber, according to some embodiments.

FIG. 3 illustrates an example male connector and an example female connector, both of which provide for optical coupling and electrically conductive coupling and may be used with the cables of FIGS. 1 and 2 according to some embodiments.

While the system of the present application is susceptible to various modifications and alternative forms, specific embodiments thereof have been shown by way of example in the drawings and are herein described in detail. It should be understood, however, that the description herein of specific embodiments is not intended to limit the system to the particular forms disclosed, but on the contrary, the intention is to cover all modifications, equivalents, and alternatives falling within the spirit and scope of the present application as defined by the appended claims.

### DETAILED DESCRIPTION

Illustrative embodiments of the system of the present application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

Over the coming years, it may be possible that networking speeds reach a bandwidth ceiling for traditional twisted pair cables for local area networks (LANs). Current existing buildings may include wiring having traditional twisted pair cables, and current construction may provide traditional twisted pair cables throughout a new building to provide access to, e.g., ethernet via registered jack (RJ) 45 connectors. However, as networking speeds increase, and as a bandwidth ceiling for the traditional twisted pair cables may be reached, owners and managers of buildings may find that there is a desire for use of higher-bandwidth physical cabling, such as for optical fiber.

Nevertheless, there may be a number of factors that may stand in the way of upgrading cabling in a building. One such factor may be cost, where an owner or manager of a building may be reluctant to incur capital costs for re-cabling or adding fiber-optic cable. Another factor may include user inertia. For instance, end users may have devices, such as ethernet switches and wireless access points that either use or support power over ethernet (POE) but do not have ports for fiber-optic cable.

Various embodiments include one or more fiber-optic cables included within a same sheath as twisted pair cabling. For new construction, various embodiments may allow for cables that include both fiber-optic and conductive twisted pairs within a same sheath to be installed in a building with little to no additional labor cost. Such cables may be used to provide networking using the twisted pair cabling, such as for ethernet, POE, or other LAN technologies. Should an occupier of a building choose to upgrade their network to fiber LAN, the occupier may already have access to fiber-optic cables through the installed cabling. The occupier may have new devices, such as optical network units (ONUs), Distributed Units (DU) positioned to be in contact with Radio Units (RUs), and/or the like, which may be communicatively coupled to the fiber-optic cables. In one example, the fiber-optic cables may be used in any appropriate fiber-based LAN, such as a passive optical network (PON) and/or the like. Furthermore, since the installed cables include conductive twisted pairs as well, the occupier may maintain use of some traditional ethernet connections if appropriate.

Also, the scope of implementations may include installing cables that include both fiber-optic cables and conductive twisted pairs as a replacement for, or in addition to, existing cables that only provide for conductive twisted pairs.

Various embodiments may further include connectors, such as a male connector that may accommodate both twisted-pair connections and an optical fiber connection and a female connector that may accommodate twisted-pair connections and an optical fiber connection.

Various embodiments may provide for point-to-point connections as well as point-to-multipoint connections.

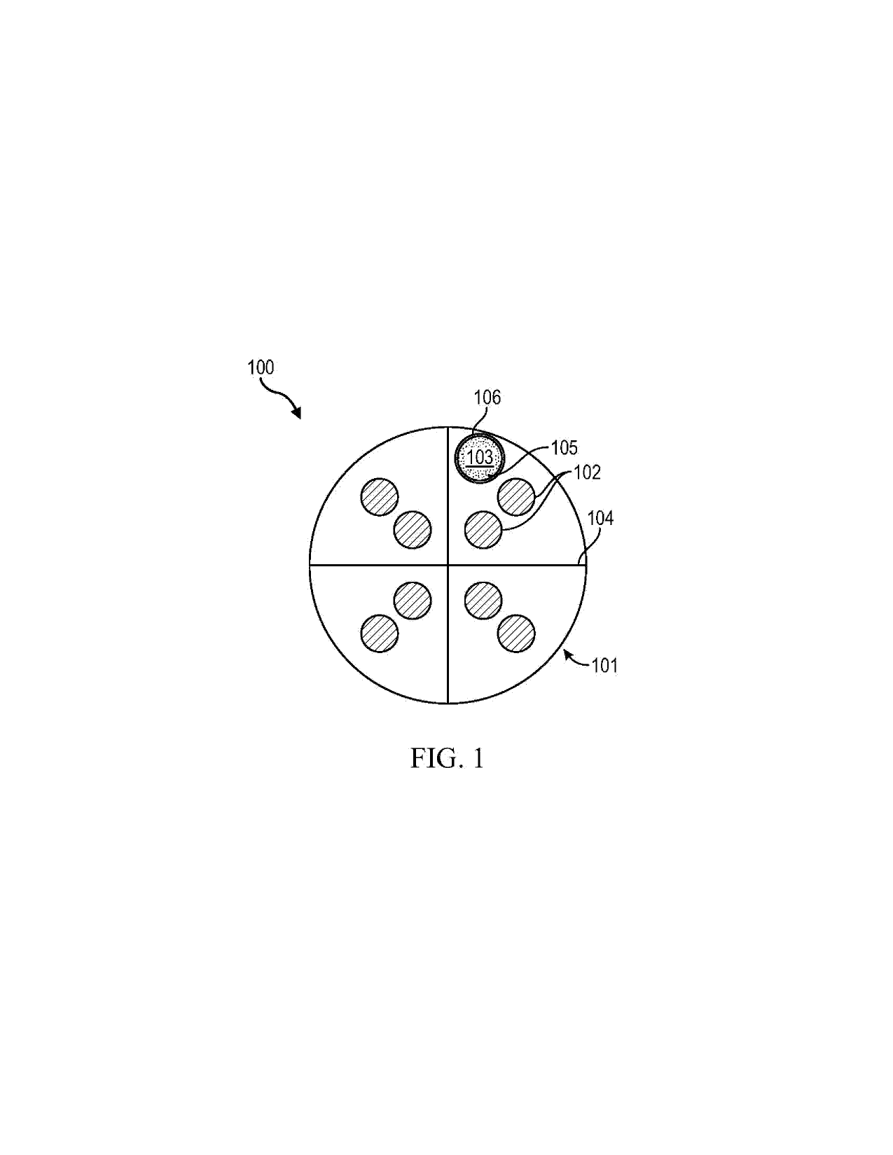

FIG. 1 is an illustration of an example cable 100, according to some embodiments. FIG. 1 is illustrated as a cross-section of an end-on view of the cable 100. The example cable 100 of FIG. 1 includes four conductive (e.g., copper) twisted pairs (e.g., 102), for a total of eight individual strands of conductor. A particular twisted pair 102 is labeled as an example, and it is illustrative of the other twisted pairs within cable 100. The twisted pairs 102 are included in the cable 100, where the cable 100 is defined by a sheath 101 on the outside surface. The sheath 101 may be constructed of plastic or other appropriate material to isolate the twisted pairs 102 and the fiber optic cable 103 from the outside environment. Each conductor within a conductive twisted pair 102 may be insulated using plastic or other appropriate material. Furthermore, each twisted-pair 102 may also be insulated and/or have shielding.

The illustrated twisted pairs 102 may be implemented using any appropriate technology, such as shielded copper twisted pairs or unshielded copper twisted pairs. Furthermore, the scope of implementations is not limited to only four twisted pairs, as the principles described herein may be adapted for more or fewer twisted pairs.

In the present example, the cable 100 includes a separator 104, which may be plastic or other appropriate insulative material. The separator 104 divides the inside volume of the cable 100 into four quadrants. Each quadrant includes one twisted-pair, and one of the quadrants further includes the fiber-optic cable 103. In this example, the fiber-optic cable 103 may include an inner glass 105 or other optic material surrounded by a cladding layer 106, though the scope of implementations may include any appropriate fiber-optic technology. The fiber-optic cable 103 of FIG. 1 may be configured as a medium allowing light to travel therethrough from a source to a destination. For instance, various wavelengths of light, such as by a laser, may be used to transmit information from source to destination through the fiber-optic cable 103.

Additionally, the scope of embodiments is not limited to only a single fiber-optic cable 103 within the sheath 101, as other implementations may include two or more fiber-optic cables 103.

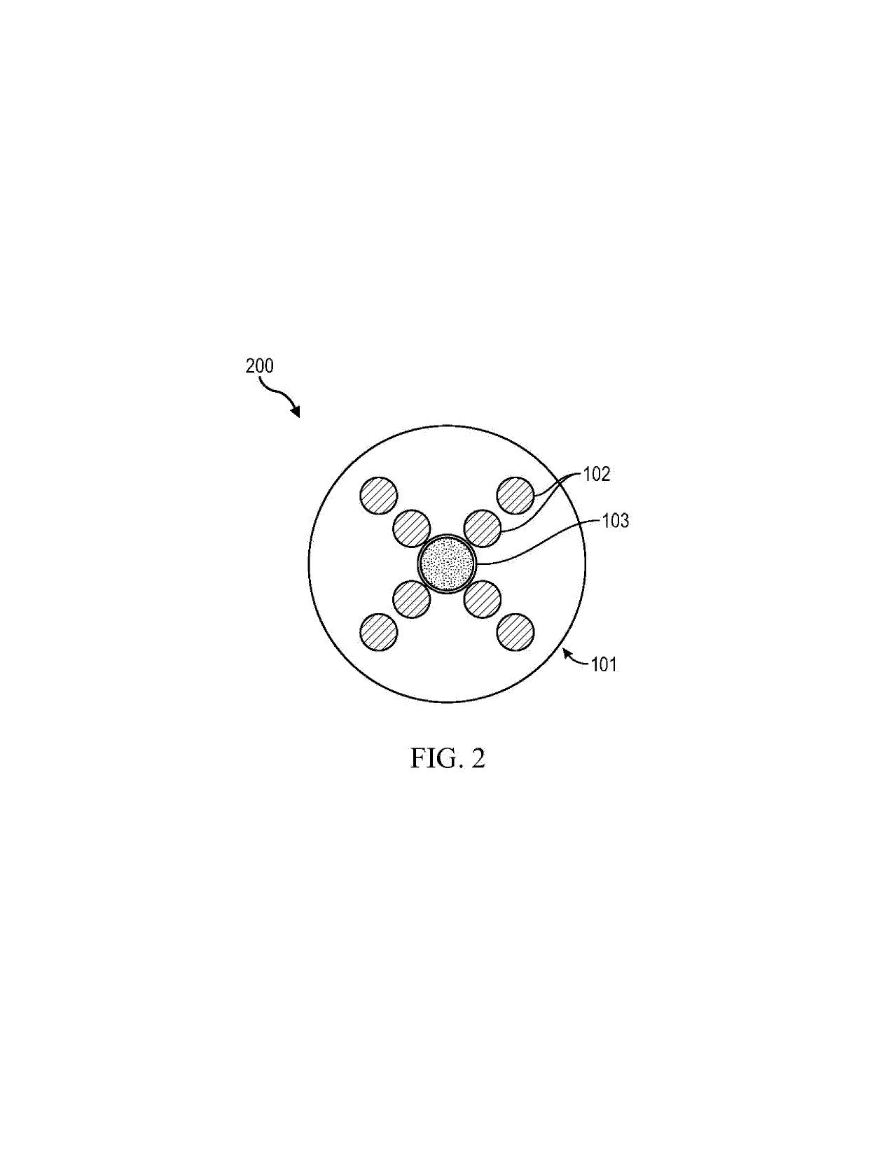

FIG. 2 is an illustration of another example cable 200, according to some embodiments. FIG. 2 is illustrated as a cross-section of an end-on view of the cable 200. The cable 200 of FIG. 2 includes four twisted pairs (e.g., 102) and a single fiber-optic cable 103. The cable 200 of FIG. 2 is different from the cable 100 of FIG. 1 in that the cable 200 of FIG. 2 does not include a separator. In other words, the scope of implementations may include a separator or may omit a separator, as appropriate. Once again, the scope of implementations may include a smaller or larger quantity of twisted pairs 102 and one or more fiber-optic cables 103. In any event, in the implementations of FIGS. 1 and 2, the fiber-optic cable 103 is bundled with the twisted pairs 102 within a same sheath 101 to make a single cable 200 in which twisted pairs 102 and at least one fiber-optic cable 103 coexist.

Cables 100 and 200 may be manufactured to have any appropriate length dimension and any appropriate diameter.

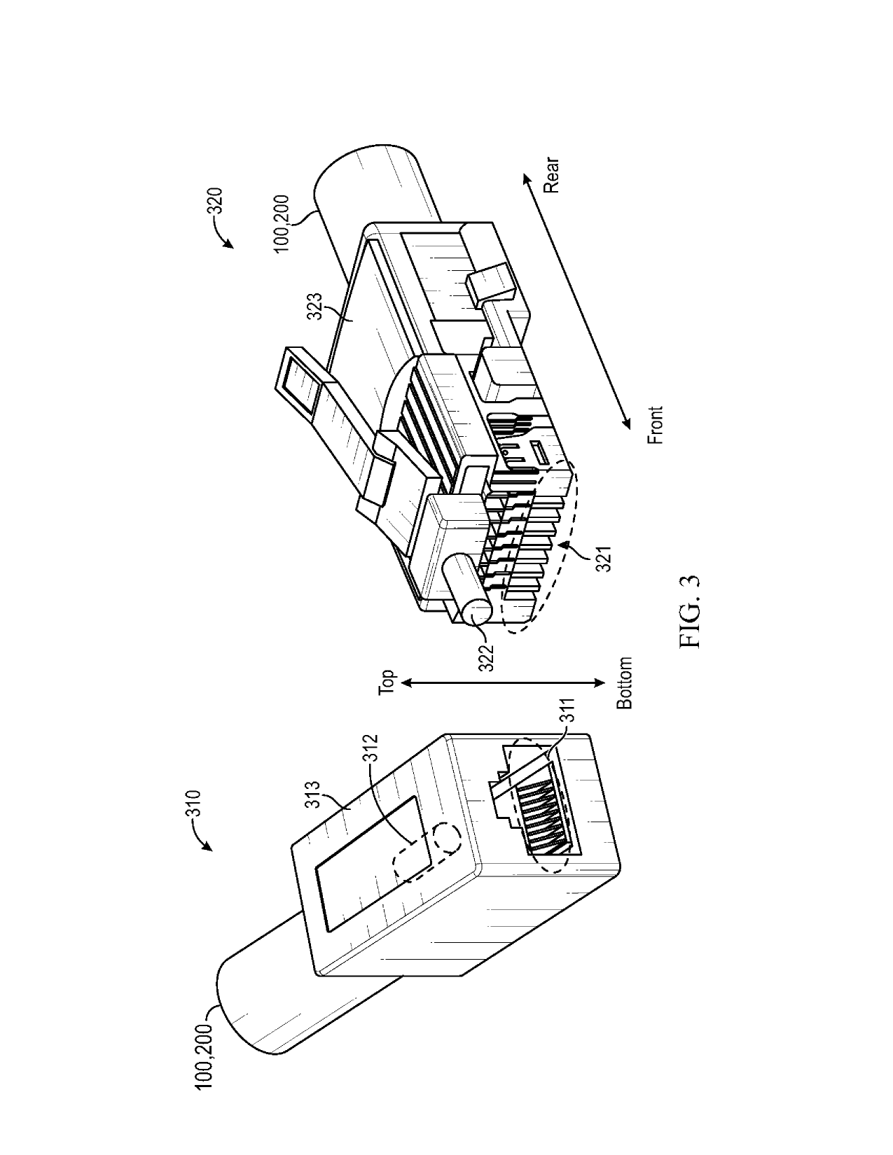

FIG. 3 is an illustration of a male connector 320 and a female connector 301 that may be used with the cables 100, 200 of FIGS. 1 and 2, according to some embodiments. The male connector 320 is based upon a form factor that may be commonly referred to as RJ45, and which may be compatible with ethernet and POE. Similarly, the female connector 310 is also based upon RJ45. Nevertheless, the scope of implementations may include any appropriate form factor.

The male connector 320 may be used in various implementations to terminate a cable 100 or 200 having both fiber-optic and conductor, such as those described above with respect to FIGS. 1 and 2. For instance, in the example of the male connector 320, it has exposed conductive (e.g., copper) terminations 321 and an exposed fiber (optical) connector 322. Inside the housing 323 of the male connector 320, the fiber-optic cable 103 may be optically coupled to the fiber connector 322, and the twisted pairs 102 may be electrically coupled to the conductive terminations 321. The housing 323 may be made of any appropriate material, such as plastic or other insulative material. The housing 323 may be made of multiple, separable parts and may be made through three-dimensional printing or other appropriate techniques. The housing 323 may be configured to accommodate an end of the cable 100 or 200.

Inside housing 313 of the female connector 310, the conductive (e.g., copper) terminations 311 are configured to make electrical contact with the conductive terminations 321 of the male connector 320. There is also a fiber (optical) connector 312 in the female connector 310, which is configured to be optically coupled to the fiber connector 322 of the male connector 320. The fiber connector 312 of the female connector 310 is shown in dashed lines to indicate that it is inside of the housing 313and not directly visible from the outside, at least when the housing 313 is opaque. The female connector 310 may be further optically or electrically coupled to further components. In one example, the female connector may be arranged so that it terminates one of the cables 100 or 200, such as described above with respect to FIGS. 1 and 2. For instance, conductive twisted pairs 102 of a cable 100 or 200 may be electrically coupled to the conductive terminations 311 in the female connector, and the fiber-optic cable 103 may be optically coupled to the fiber connector 312 of the female connector 310. In one example, a female connector 310 may be implemented as a wall jack. In another example, a female connector may be implemented as part of a communications component (e.g., an ONU). Thus, in some examples, the female connector 310 may not be terminated by a cable 100, 200 but may instead be terminated to other components. The housing 313 may be made of any appropriate material, such as plastic or other insulative material. The housing 313 may be made of multiple, separable parts and may be made through three-dimensional printing or other appropriate techniques.

The principles described above may be used for adapting other connector form factors for use with a cable 100 or 200 having both conductive twisted pairs 102 and fiber optic cables 103.

Various embodiments may include installing cables and connectors, such as those described above with respect to FIGS. 1-3. Other embodiments may include using cables and connectors, such as those described above the respect to FIGS. 1-3, to communicate digital data electrically, optically, or both.

In one example, the twisted pairs 102 may conform to a standard, such as Category 5 or Category 6, for providing data transmission. For instance, both Category 5 and Category 6 use four individual pairs (such as shown in FIGS. 1, 2) for a total of eight conductors. When terminated in male connector 320, the conductors of the twisted pairs may make conductive contact with the conductive terminations 321 in any appropriate arrangement. In some examples, the twisted pairs 102 may be configured for data traffic only. In other examples, the twisted pairs 102 may be configured for data traffic as well as power transmission.

FIG. 3 includes a label illustrating top sides and bottom sides of the connectors 310 and 320. In the example shown, the fiber connector 322 may be arranged so that it is exposed outside of the front of housing 323 and is located above the conductive terminations 321. Similarly, the fiber connector 312 may be located above the conductive terminations 311 in the female connector 310. In an example in which the male connector 320 and the female connector 310 are mated, the conductive terminations 321 and 311 may make electrical contact, and the fiber connectors 322 and 312 may make physical contact, thereby allowing for data transmission by electrical signals and/or optical signals. In some examples, the conductive terminations 311, 321 may also be used for power transfer.

The fiber connectors 312, 322 may be constructed of any appropriate materials. In one example, the fiber connectors 312, 322 may include an optical material (e.g., glass) with a cladding layer, which may be the same as or similar to the materials implementing the fiber-optic cable 103.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. A cable comprising:
a plurality of conducting twisted pairs;
a fiber-optic cable; and
a sheath disposed around the plurality of conducting twisted pairs and the fiber-optic cable.

2. The cable of claim 1, wherein the cable does not include a separator between the plurality of conducting twisted pairs.

3. The cable of claim 1, wherein the cable includes a separator between the plurality of conducting twisted pairs.

4. The cable of claim 3, wherein the separator creates four quadrants within the cable, each quadrant including at least one pair of the plurality of conducting twisted pairs.

5. The cable of claim 1, wherein the plurality of conducting twisted pairs comprise copper wires.

6. The cable of claim 1, wherein the plurality of conducting twisted pairs includes four twisted pairs.

7. The cable of claim 6, wherein the four twisted pairs include eight conductors total.

8. The cable of claim 1, further comprising:
a male connector, physically attached at an end of the cable, wherein the male connector includes a plurality of conductive terminations, each of the conductive terminations being coupled to a respective conductor of the plurality of conducting twisted pairs.

9. The cable of claim 8, wherein the male connector further includes a fiber connector, which is configured to terminate the fiber-optic cable.

10. A device comprising:
a housing;
a plurality of conductive terminations; and
an optical connector, wherein the housing is configured to accommodate an inserted cable, wherein the plurality of conductive terminations are configured to terminate a plurality of conductive pairs of the cable, and wherein the optical connector is configured to terminate a fiber-optic cable within the cable.

11. The device of claim 10, wherein the plurality of conductive terminations are arranged at a bottom side of the housing.

12. The device of claim 11, wherein the optical connector is arranged above the conductive terminations.

13. The device of claim 12, wherein the optical connector is exposed outside of the housing.

14. The device of claim 11, wherein the device conforms to a male connector form factor.

15. The device of claim 11, wherein the device conforms to a female connector form factor.

16. A device comprising:
a cable having an end, the cable further having a plurality of twisted conducting pairs and a fiber-optic cable contained within a sheath; and
a male connector arranged at the end of the cable, wherein the male connector is configured to accommodate the end of the cable at least partly inside a housing of the male connector, wherein the male connector includes conductive terminations exposed at an outside surface the housing, the conductive terminations configured to terminate the plurality of twisted conducting pairs, further wherein the male connector includes an optical connector configured to terminate the fiber-optic cable.

17. The device of claim 16, wherein the conductive terminations have an arrangement that conforms to registered jack (RJ) 45.

18. The device of claim 16, wherein the optical connector is arranged closer to a top side of the male connector than are the conductive terminations.

19. The device of claim 16, wherein the cable includes a separator configured to divide the twisted conducting pairs into a plurality of quadrants.

20. The device of claim 16, wherein the plurality of twisted conducting pairs comprises eight individual conductors.
